(19) United States
(12) Patent Application Publication
(10) Pub. No.: US 2002/0083016 A1
(43) Pub. Date: Jun. 27, 2002

(54) System and method for enabling transactions over a network using multiple channels

(76) Inventors: Darren L. Dittrich, Dallas, TX (US); Jeffrey J. Dittrich, Dallas, TX (US)

Correspondence Address: SELL.COM, INC., Suite 110, 14800 Quorum Drive, Dallas, TX, 75240, US

(21) Appl. No.: 09/746,151

(22) Filed: Dec. 22, 2000

(51) Int. Cl. G06F 17/60

(52) U.S. Cl. 705/80

(57) ABSTRACT

A method of processing a transaction over a network, the method includes generating a listing associated with a first user and a good or service and conducting a first transaction associated with the listing in response to a selection of a second user. The method also includes conducting a second transaction associated with the listing in response to a selection of a third user and concluding the first transaction in response to the first user confirming an acceptance of the second user. The method further includes canceling the second transaction in response to concluding the first transaction.

### TECHNICAL FIELD OF THE INVENTION

This invention relates in general to the field of network communications, and more particularly to a system and method for enabling transactions over a network using multiple channels.

### BACKGROUND OF THE INVENTION

Current Internet commerce mechanisms require that an offeror who buys or sells goods or services make a commitment to a particular commerce forum that may foreclose many other equally effective channels of commerce. Such mechanisms also require the offeror to commit to the offer he or she is posting on such forum. If the offeror does not follow through on such offer after the response of an interested responder, negative consequences may ensue such as negative feedback or being restricted from participating in future transactions using the same forum. Additionally, many of such Internet commerce mechanisms do not easily allow for a complex and interactive negotiation process that may be available in more traditional commerce mechanisms.

### SUMMARY OF THE INVENTION

In accordance with the present invention, a system and method for enabling transactions over a network using multiple channels is disclosed that substantially reduces disadvantages associated with previous systems and methods of network commerce mechanisms.

A method of processing a transaction over a network is disclosed. The method includes generating a listing associated with a first user and a good or service and conducting a first transaction associated with the listing in response to a selection of a second user. The method also includes conducting a second transaction associated with the listing in response to a selection of a third user and concluding the first transaction in response to the first user confirming an acceptance of the second user. The method further includes canceling the second transaction in response to concluding the first transaction.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is one embodiment of a system for enabling transactions over a network using multiple channels according to the teachings of the present invention;

FIG. 2 is one embodiment of a computer used to implement various components of the system illustrated in FIG. 1;

FIG. 3 is one embodiment of a process for conducting a transaction over a network according to the teachings of the present invention;

FIG. 4 is one embodiment of a process used to process a user selection received during the course of a transaction conducted over a network according to the teachings of the present invention;

FIG. 5 is one embodiment of a map of a state diagram used to manage the states of a transaction that is implemented according to the teachings of the present invention; and

FIG. 6 is one embodiment of a table used to allow a user to view listings and manage transactions according to the teachings of the present invention.

### DETAILED DESCRIPTION OF THE INVENTION

FIG. 1 illustrates a system 10 for enabling the transaction of goods and services over a network. More particularly, system 10 allows a buyer or seller of goods or services (the “offeror”) to market or solicit such goods or services over a network in such a manner that allows the offeror to solicit purchasing or sales commitments from a plurality of responders without committing the offeror to enter into a transaction with all or any of the responders. Unlike online auction houses or other electronic forums, system 10 allows an offeror to use many different forums and/or media with which to market or solicit a particular good or service. If a newspaper advertisement or storefront marketing or solicitation effort results in a more lucrative or otherwise suitable opportunity for the offeror, any responses or commitments received using system 10 may be rejected by the offeror. Additionally, system 10 allows for a dynamic negotiation process to take place between buyers and sellers, enabling a methodology for offers and counteroffers to be exchanged, whether such offers and counteroffers relate to price, quantity, commitment level, shipping, delivery time, financing alternatives, or any other suitable derivations of the original offer conditions. This negotiation exchange is private between each buyer and seller; a buyer is not aware of other buyers' interactions with a seller. Such negotiation process is referred to throughout this specification as a transaction. A negotiation that results in a purchase or sale is referred to as a completed or finalized transaction.

System 10 includes a transaction server 20 in communications with a web server 40 and one or more clients 80 over a network 60. Network 60 may be one or more private or public networks using dedicated or switched links. For example, in one embodiment servers 20 and 40 may communicate using a private network while server 40 and clients 80 may communicate using a public network such as the Internet whether connecting directly to the Internet, or indirectly via links in a wireless network such as a cellular network and a Public Switched Telephone Network (PSTN). Each of the communications links making up network 60 may be implemented using fiber, cable, twisted-pair, satellite, radio, microwave, laser or other suitable wireless links.

Transaction server 20 includes a message manager 21, a state manager 22, a state table 23, a history file 25, a feedback manager 26, a listing table 27, a financial engine 28, and a user database 29. Transaction server 20 may be any specialized or general-purpose computing platform having processing components, memory, and communications interfaces sufficient to interact with and communicate data over network 60. The components of transaction server 20 are identified according to functional purpose, and may all be executed using the same or different software routines stored in one or more memory components and executed using one or more processing components. In addition, transaction server 20 may also be integrated in a single device with web server 40, such that a single server fulfills the functionality of both servers 20 and 40.

Message manager 21 is a messaging platform capable of using one or more methods to communicate information between the participants of a potential transaction. For example, in one embodiment message manager 21 may be a web page or JAVA servlet by which users of system 10 may view messages generated by another user or automatically by message manager 21 in response to a user selection (also referred to as a transaction event) associated with transactions associated with such users of system 10. Alternatively, message manager 21 may be an automated email, instant messaging, wireless paging, voicemail, or other suitable messaging application generating messages to send to a user to notify such user of transaction events. A transaction event or user selection may be an offer, counteroffer, response, acceptance, rejection, or informational message sent by another user which may include additional questions or information concerning a potential transaction.

State manager 22 and state table 23 are, respectively, a software routine and database used to keep track of the state of a particular transaction. State manager 22 includes algorithms directed to determining the next state of a transaction in response to a transaction event and the current state of the transaction. State table 23 maintains the current state of each transaction in system 10 using one of a plurality of entries 24.

History file 25 is a file responsible for maintaining the history of transaction events associated with each transaction. Portions of history file 25 may be viewed by a user of system 10 with respect to the history of a user's participation with a particular transaction.

Feedback manager 26 is a platform whereby users of system 10 may leave feedback concerning other users with which they may have entered into transactions. Feedback manager 26 may include assigning a rating to each user of system 10 and storing text comments about each user that are entered by other users.

Listing table 27 is a database of listings offered by the users of system 10. For example, listings may include products or services that are either for sale or that a buyer desires to purchase. Listings may also be requests for bids, quotes, or proposals. Listing table 27 may include prices, quantities, geographic locations, dates, shipping and/or delivery requirements, credit information, or any other suitable term or condition placed on the product or service associated with the listing. Listing table 27 may be organized, indexed, and searchable by market type, product or service category, listing offeror, price, geography, or any other suitable differentiation. Listing table 27 may include user listing subtable 33 that is customized for a particular user based on the user's current transactions, transaction history, user profile, offered listings, or any other suitable criteria. In one embodiment, user sublisting table 33 is an interface to both listings of offers in listing table 27 and the messaging capabilities of message manager 21. For example, a listing may include links to notification methods as further described in FIG. 6.

Financial engine 28 includes escrow module 30, credit module 31, and payment module 32. Escrow module 30 includes tables, routines, links, requirements, and procedures used by users of system 10 to escrow money associated with transactions entered into using system 10. Escrow module 30 may be used to offer third party escrow services, not offered by the owner or operator of system 10. Credit module 31 includes a financial engine allowing a user to enter information associated with a particular credit source of such user when completing a transaction, where such credit source is used to communicate funds to another user. Payment module 32 enables direct transfer of funds between the financial institutions of users of system 10 entering into a transaction.

User database 29 is a database of user profiles maintained by system 10. User database 29 includes personal identity, contact and financial information about each user of system 10. User database 29 also contains both links to any transactions regarding which a particular user has initiated a transaction event and to any feedback associated with such particular user. User database 29 may also store preferences of a particular user as to particular types of listings the user has interest in, payment arrangements, preferred contact methods, custom search criteria for listings, and any other information regarding a particular user that may be suitable for system 10 to maintain regarding such user.

Web server 40 provides a web-based interface to the contents of transaction server 20. Web server 40 stores web pages, JAVA servlets, and other suitable content and executables to enable users of system 10 to easily access the features and capabilities of transaction server 20. Web server 40 may be integrated with transaction server 20 in a single server or may be linked to transaction server 20 via a private or public network. In one embodiment, transaction server 20 is a voice-enabled server allowing users the capability of using voice commands to access the content of transaction server 20.

In one embodiment, each of clients 80 is a personal computer; alternatively, clients 80 may each be a client, workstation, terminal, personal computer, web appliance, personal digital assistant, cellular telephone, pager or any other suitable computing device having input and output modules that enable a user to enter and view data. Clients 80 may each include a web browser or other interface software and/or hardware, volatile or non-volatile memory, processor and/or other processing components, and/or other software, hardware, and peripherals suitable for such computing devices.

Although servers 20 and 40 and clients 80 are referred to in the nomenclature of a client/server environment, any suitable arrangement of computing devices may be utilized.

In system 10, HyperText Transfer Protocol (HTTP) is used to communicate information between servers 20 and 40 and clients 80. Alternatively, File-Transfer Protocol (FTP), Telnet, Usenet, mobile agents, cookies, paging, electronic mail, instant messaging, bulletin boards, or any other suitable communication techniques may be utilized. Clients 80 may maintain and execute browsers or other suitable parsing programs for accessing and communicating information addressed by Uniform Resource Locators (URLs). Any suitable communications protocol may be implemented in combination with one or more generally available security and/or encryption techniques to ensure the secure, private communication of data between computer servers 20 and 40 and clients 80.

In the illustrated embodiment, components of system 10 are implemented in a programming environment that supports access or linking to various sources of information in system 10 using URL addresses. As such, the content of such modules and databases may be constructed using Hypertext Mark-Up Language (HTML), Extensible Mark-Up Language (XML), other forms of Standard Generalized Mark-Up Language (SGML), Virtual Reality Mark-Up Language (VRML), Javascript, or any other appropriate content development language. The modules of system 10 may also include program code, such as applets or servlets written in JAVA, or other appropriate self-executing code.

Although the components of transaction server 20 are illustrated in this FIG. 1 as separate databases, modules, subsystems and other illustrated components, each of such separate components may be implemented using a single processor for transaction server 20 such that the single processor accesses stored algorithms, executables, and other data that are stored in read only memory, for example, and executed using random access memory. Likewise, such separate databases, modules, subsystems and other illustrated components may be combined, separated or distributed across one or more processing and/or memory devices. Memory for such databases, modules, subsystems, or other illustrated components of transaction server 20 may be implemented using one or more files, data structures, lists, or other arrangements of information stored in one or more components of random access memory, read-only memory, magnetic computer disks, compact disks, other magnetic or optical storage media, or any other volatile or non-volatile memory.

Likewise, it should be understood that any components of system 10 may be internal or external to the illustrated components of system 10, depending on the particular implementation. Also, such databases, modules, subsystems or other components may be separate or integral to other components. Any appropriate referencing, indexing, or addressing information can be used to relate back to an address or location of a database, file or object within system 10.

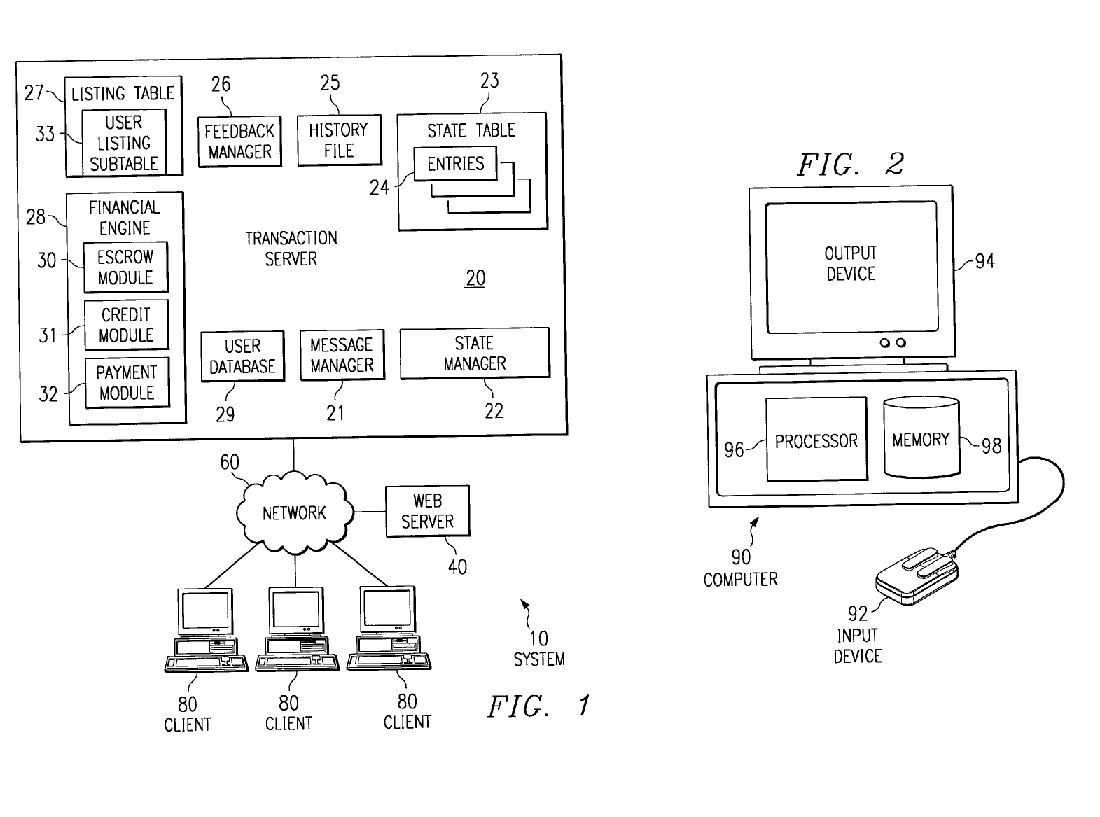

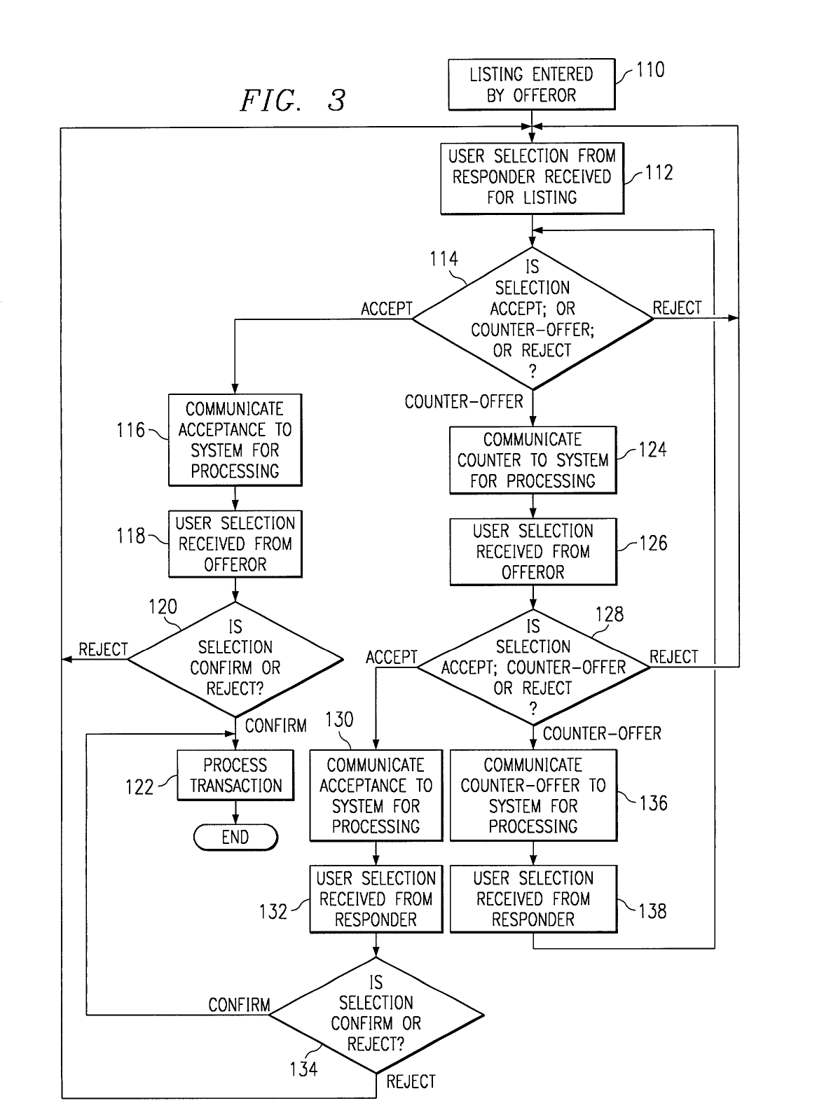

In operation, system 10 is described more particularly with reference to FIGS. 2 through 6. In general, a user profiled in user database 29 may create a listing in listing table 27 that may then be viewed, categorized, customized, and interacted with via user listing subtable 33. When creating such a listing, a user may specify responder screening guidelines. For example, a user may block particular other users with which such user does not wish to do business because of a negative history with such other users, because of negative feedback associated with such users, or for any other reason. Additionally, the user may specify criteria such as a feedback rating, a length of time using the commerce forum, location, type of business, or any other desired requirement that may be verified by system 10 using any of the databases, tables, or files maintained by transaction server 20. A user may also set additional options, such as auto declines for counteroffers in general or counteroffers offering unacceptable amounts, delivery conditions, or other terms. Such auto declines will then automatically generate a user selection in response to user selections of responders that respond with unacceptable counteroffers or conditions. Autodeclines may be tied to a timer such as, for example, a timer that delays sending the response until an average user response time has elapsed. In such a manner, a user selection may be generated in response to another user such that it does not appear automated.

State manager 22 and message manager 21 then cooperate to manage transactions associated with the created listing. A transaction refers to a negotiation between the offeror of a listing and a responder to the offer. A listing can have as many transactions as there are responders, all of which may overlap in negotiation. State manager 22 manages one of entries 24 for each of the transactions for a particular listing and keeps track of the state of the transaction and what alternative user selections are available to both offeror and responder for any given transaction state.

Message manager 21 generates notification messages to offeror and responder as a transaction progresses and the state of the transaction changes. Eventually, the transaction concludes when the offeror has confirmed the acceptance of a responder or removed the listing. Until such confirmation, the offeror is not obligated to any of the many responders who may be negotiating with the offeror. In such a manner, the offeror may pursue many marketing channels associated with a listing, whether such channels are to multiple responders using system 10 or through channels outside of system 10 in other commerce websites, through print media, or conventional brick and mortar sales.

Other components of system 10 add additional features and functionality to assist offerors of and responders to listings. History file 25, feedback manager 26, and user database 29 may assist offerors and responders to make an informed decision on who they will do business with and on what terms. Listing table 27 is a searchable, customizable on-line catalog of all listings. Financial engine 28 provides functionality to those hosts of system 10 who may wish to be directly involved in transactions and their fulfillments rather than being an uninvolved, neutral forum for private transactions between users.

Referring to FIG. 2, servers 20 and 40 and clients 80 may operate on one or more computers 90. Each computer 90 includes one or more input devices 92 such as a keypad, touch screen, mouse, microphone, or other suitable pointer or device that can accept information. An output device 94, such as a speaker, monitor or other display, for example, conveys information associated with the operation of servers 20 and 40, or clients 80, including digital data, visual information, and/or audio information. A processor 96 and its associated memory 98 execute instructions and manipulate information in accordance with the operation of system 10. For example, processor 96 may execute coded instructions that are stored in memory 98. Computer 90 may also include fixed or movable storage media such as a magnetic computer disk, CD-ROM, or other suitable media to either receive output from, or provide output to, servers 20 and 40 and clients 80.

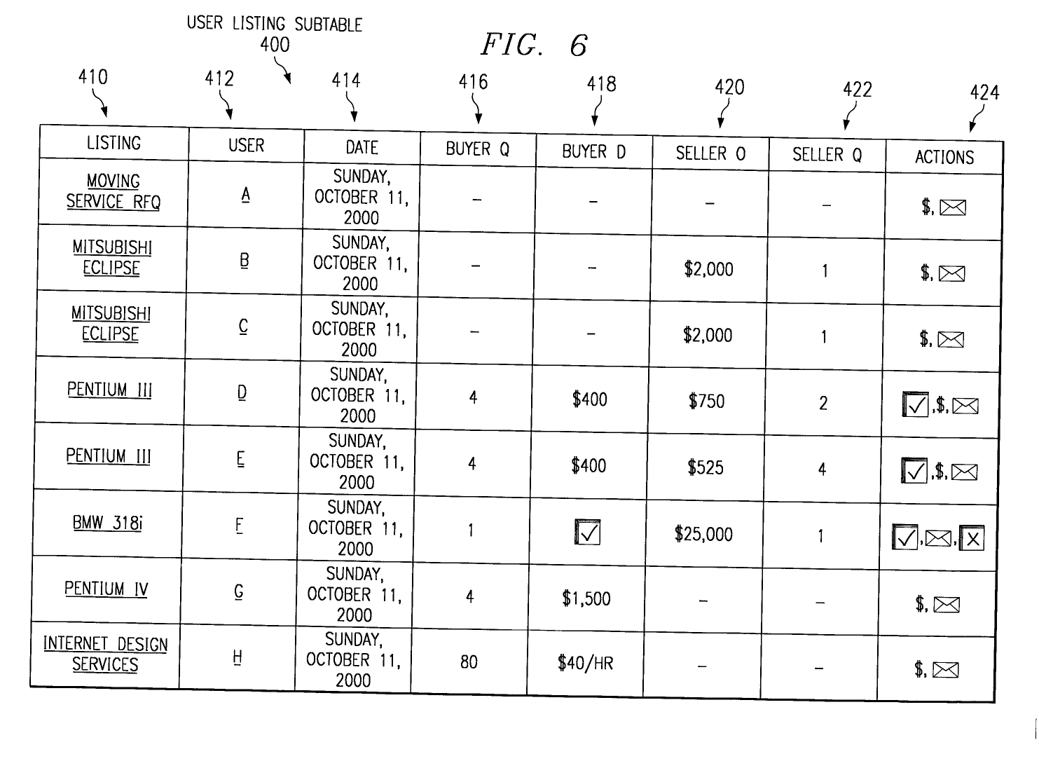

With reference to FIG. 3, a process for performing a transaction over a network is illustrated. In step 110, a listing is entered by a user (hereafter referred to as an offeror). In step 112, a user selection is received after a user (hereafter referred to as a responder) has viewed the listing and entered a selection using a client 80 to access web server 40. In step 114, transaction server 20 determines if the user selection is an acceptance, a rejection, or a counteroffer. Although not illustrated in this FIG. 3, at any time, a user selection may be simply a request to send a message to the offeror or responder as illustrated in transaction state map 300 of FIG. 5. Such a message does not change the state of the transaction, and does not therefore cause any progression in the process illustrated in this FIG. 3.

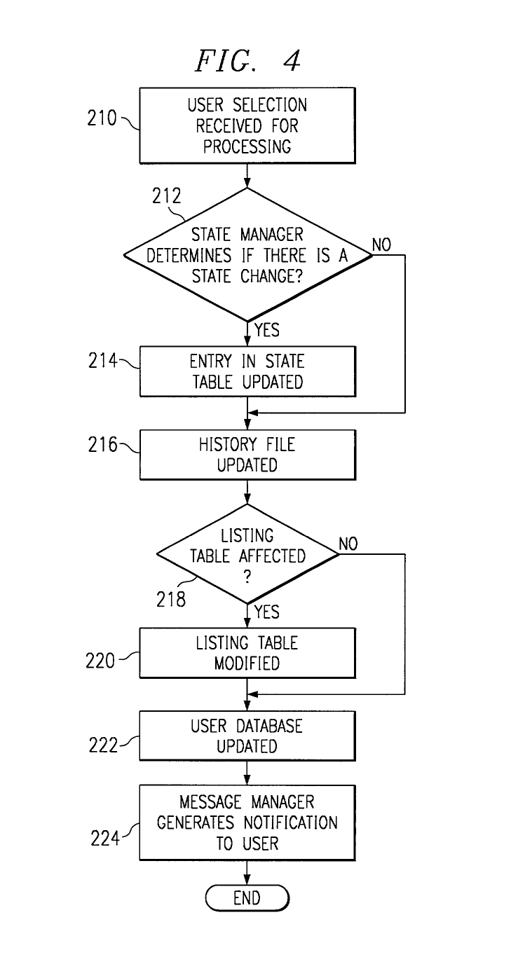

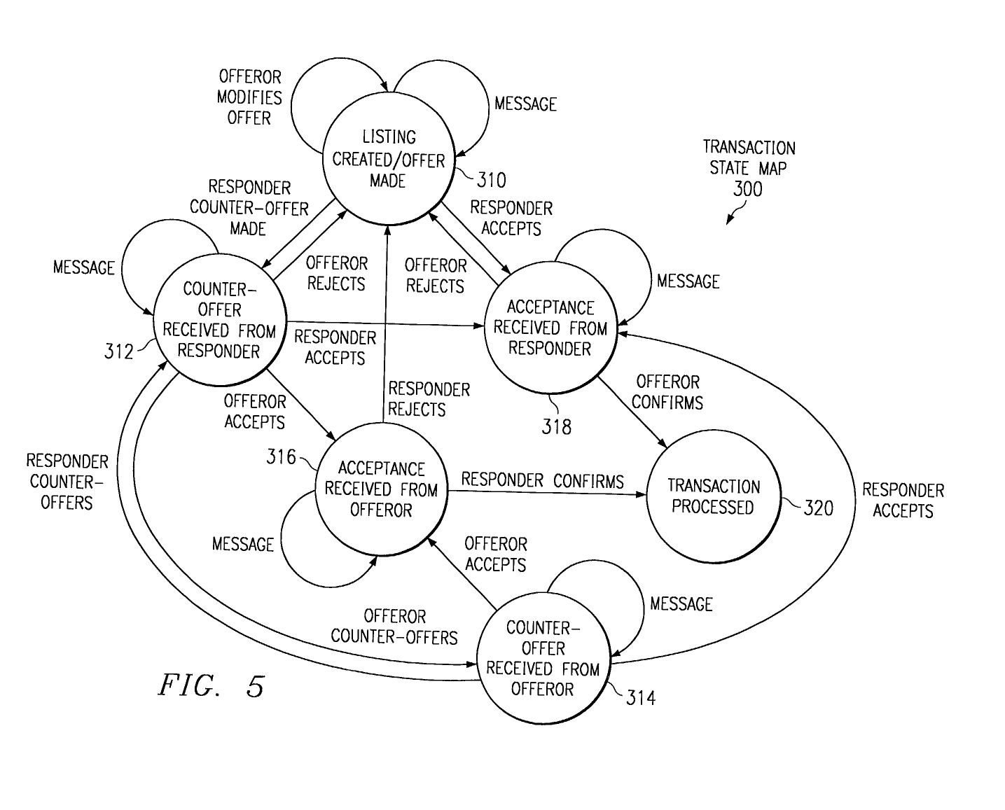

If the user selection is determined in step 116 to be an acceptance, the user selection is communicated in step 116 to appropriate components of system 10 for processing, as further described with reference to FIG. 4. In step 118, a user selection is received from the offeror who has received notification of the acceptance of the responder and initiated the user selection in response. In step 120, transaction server 20 determines if the user selection is a confirmation or a rejection by the offeror of the responder's acceptance. If the user selection is a rejection, transaction server 20 returns to the beginning of the process between steps 110 and 112 to await another user selection from an interested responder.

If the user selection is a confirmation, the transaction has been accepted by the responder and confirmed by the offeror meeting the necessary requirements for final processing by transaction server 20. In particular, transaction server 20 may prompt the responder and/or offeror to enter information associated with escrow module 30, credit module 31, and/or payment module 32. Alternatively, transaction server 20 may merely initiate notification of the responder via message manager 21 so that offeror and responder can privately arrange settlement and delivery of the transaction.

If the user selection is determined in step 114 to be a rejection, transaction server 20 returns to the beginning of the process between steps 110 and 112 to await another user selection from an interested responder. In one embodiment, a user may not need to affirmatively reject a listing if the user is not interested, but merely select listings that the user has interest in. In such an embodiment, the determination in step 114 is to determine if a user selection is an acceptance or counteroffer.

If the user selection is determined in step 116 to be a counteroffer, with a change in either the price, quantity, or conditions of the transaction allowed by transaction server 20 to be altered in the counteroffer, transaction server 20 communicates the counteroffer to the appropriate components of transaction server 20 for processing in step 124, as further described with reference to FIG. 4. In step 126, a user selection is received from the offeror who has received notification of the counteroffer of the responder and initiated the user selection in response. In step 128, transaction server 20 determines if the user selection is an acceptance, rejection, or counteroffer.

If the user selection is determined to be an acceptance in step 128, the acceptance is communicated by transaction server 20 to the appropriate components of transaction server 20 for processing in step 130, as further described with reference to FIG. 4. In step 132, a user selection is received from the responder who has received notification of the acceptance of the offeror and initiated the user selection in response. In step 134, transaction server 20 determines if the user selection is a confirmation or a rejection.

If the user selection is a confirmation, transaction server 20 processes the transaction as described in step 122. If the user selection is a rejection, transaction server 20 returns to the beginning of the process between steps 110 and 112 to await another user selection from an interested responder.

If the user selection is determined in step 128 to be a counteroffer, transaction server 20 communicates the counteroffer to the appropriate components of transaction server 20 for processing in step 136, as further described with reference to FIG. 4. In step 138, a user selection is received from the responder who has received notification of the counteroffer of the offeror and initiated the user selection in response. Control then proceeds to step 114 where transaction server determines if the user selection is an acceptance, a rejection, or another counteroffer of the responder and the process continues as earlier described.

If the user selection is determined in step 128 to be a rejection, transaction server 20 returns to the beginning of the process between steps 110 and 112 to await another user selection from an interested responder.

Now referring to FIG. 4, a user selection associated with a listing is received from a user in step 210 by transaction server 20 for processing. In step 212, state manager 22 determines if the user selection has changed the state of the transaction associated with that listing.

For example, state manager 22 is programmed to change the state of the transaction if an acceptance, counteroffer, confirmation, or rejection is received as a user selection by transaction server 20. State manager may be programmed not to change the state of the transaction if a user selection corresponding to a message notification is received.

If state manager 22 determines that a change of state in the transaction has occurred because of the received user selection, in step 214 state manager updates one of entries 24 that is associated with that particular transaction. How such entry 24 is updated depends on the current state of the transaction immediately prior to the user selection being received and the type of user selection received.

For example, if the current state of the transaction was an offer or counteroffer, entry 24 will be updated in completely different ways depending on whether the received user selection is an acceptance or a rejection. The process of state determination is more fully described with reference to FIG. 5.

As described with reference to FIG. 1, each transaction between two users associated with a particular listing has a separate entry 24. Thus, user A may have five ongoing transactions with five different users B through F all associated with the same product listing. Thus, system 10 allows user A to concurrently negotiate with five different parties regarding only one listing, and then select which one of the five parties he wants to enter into a completed transaction with.

Whether or not one of entries 24 is updated in step 214, history file 25 is updated in step 216. History file 25 is updated regardless of the type of user selection that is received, and creates a stored record of all transactions associated with any listing. A user may use history file 25 to determine characteristics of the market for offered products or services, to review the history of a specific transaction, to make pricing decisions, or to determine any other suitable information to aid such user in present or future transactions.

In step 218, transaction server 20 determines if listing table 27 is affected by the received user selection.

For example, a confirmation by an offeror after such offeror has received an acceptance may cause a listing to be deleted, updated for reduction in quantity, updated with an indication that a transaction is pending, or any other suitable update based on the fact that a transaction has been completed regarding the listing. If listing table is affected, listing table is modified in step 220 as just described.

Whether or not listing table 27 is updated in step 220, user database 29 is updated in step 222. More particularly, the records of the two users involved in the transaction associated with the received user selection are updated to reflect the changed circumstances of the selection. User sublisting table 33 may also be updated to reflect a change in such transaction as further described with reference to FIG. 6.

In step 224, message manager 21 notifies the other user involved in the transaction that a user selection has been received related to the transaction. Thus, this other user may review the user selection and determine a subsequent user selection to make in response to the user selection received in step 210. Such subsequent user selection is then processed as described in FIG. 3 and this FIG. 4.

With reference to FIG. 5, a transaction state map 300 is illustrated. Transaction state map 300 may be used by state manager 22 to determine the state of a transaction associated with a listing using the former state of the transaction and a received user selection. A user selection from either the offeror of a listing or a responder to the listing may change the state of the transaction.

Regardless of the state a transaction is currently in, receiving a user selection corresponding only to messaging between users will not change the state of a transaction. More particularly, in transaction state map 300, state 310 corresponds to a state created when a listing is created thereby generating an offer.

During state 310, an offeror may modify the original terms of the offer while remaining in state 310. A responder to the offer may make a counteroffer thereby changing the state of the transaction from state 310 to state 312. State 312 therefore corresponds to the state where a counteroffer is received from a responder. If the offeror counteroffers in turn, the state of the transaction changes to state 314, corresponding to a state where a counteroffer has been made to the responder. As illustrated, a second counteroffer from the responder returns the state of the transaction to state 312, allowing an infinite number of negotiations between the offeror and the responder. If offeror instead accepts during state 312, the state of the transaction changes to state 316, corresponding to a state of acceptance of the offeror.

During state 312, despite the fact that a counteroffer has been made by the responder, the responder may change the responder's mind and accept the offeror's original offer changing the state of the transaction to state 318, corresponding to a state if acceptance of the responder. Also, the responder may accept the offeror's counteroffer while in state 312, again changing the state of the transaction to state 318.

Likewise, during state 314, despite the fact that a counteroffer had been made by the offeror, the offeror may choose to accept the responder's counteroffer changing the state of the transaction to state 316.

During state 316, the responder may either confirm or reject the offeror's acceptance. If the responder confirms the offeror's acceptance, the state of the transaction changes to state 320 corresponding to a state where the transaction is completed and processed for fulfillment. If the responder rejects the offeror's acceptance, the state of the transaction returns to state 310, where the offeror may either modify his latest offer or responder may initiate a new counteroffer.

Likewise, during state 318, the offeror may either confirm or reject the responder's acceptance. If the offeror confirms the responder's acceptance, the state of the transaction changes to state 320 corresponding to a state where the transaction is completed and processed for fulfillment. If the offeror rejects the responder's acceptance, the state of the transaction returns to state 310 as described above.

Although not illustrated for every state, in one embodiment an offeror or responder may elect not to respond, or may create an additional overriding offer or counteroffer at any time until the transaction has entered an acceptance state (either 316 or 318).

Importantly, an offeror may have many simultaneous and overlapping transactions for a unique product or service being processed at any one time. Once one of the transactions has entered state 320, however, the remaining transactions and any pending offers, counteroffers, and acceptances are withdrawn. Thus, the confirmation required in steps 316 and 318 allows the offeror to have several pending acceptances or counteroffers for the same listing. The responder associated with each transaction may only have access to the history and current state of his or her transaction, allowing the offeror to negotiate separate deals with different responders without the responders being aware of the terms being offered to each other. Additional states may be added to transaction state map 300 to add further detail, user selections, or sequences without departing from the scope of the present invention.

Now referring to FIG. 6, a user listing subtable 400 is illustrated. Although user listing subtable 33 is illustrated as part of listing table 27 in FIG. 1, subtable 400 may be used in a variety of different ways in a variety of different formats. For example, in one embodiment subtable 400 may serve as the user interface with message manager 21, thereby allowing a user to receive messages and notifications of user selections organized by listing. In another embodiment subtable 400 may form part of user database 29, allowing a user to call up subtable 400 to view all of the transactions associated with the user. Subtable 400 may only include listings with which a user is currently involved in a transaction, or only listing for which the user is the offeror. A particular user may have more than one subtable 400, corresponding to particular vertical markets, product types, service types, or differentiating between those listings for which the use is an offeror or responder.

In the illustrated example of user listing subtable 400, information is organized in several columns.

Column 410 includes the names, subject matters, or other identifiers of listings which may also be links connecting additional web pages, forms, or data sheets including further information regarding the listing and associates terms and conditions. As illustrated, some of the listings are RFQs while others are product listings or service offerings.

Column 412 includes a user identifier corresponding to a user name or email address associated with the transaction. For example, the user identifier may correspond to the offeror of the listing, the opposing party in a transaction associated with the listing, a responder to the listing, or one or more other users associated with the listing, whether in one or more columns.

Column 412 may also be a link to an email form, user profile, instant messaging interface, telephone number, or other information or contact method associated with the indicated user.

Column 414 is a date that may correspond to an original offer or response date, the date associated with the latest user selection received, the date associated with an email message received, or one or more other suitable dates associated with the listing in column 410. Columns 416 and 418 correspond to the latest quantity and price for the listing in column 410 that the buyer has offered that are associated with the user in column 412. As illustrated, for items where there are multiple transactions being processed such as with users D and E, the same offer may be made to more than one user.

Likewise, columns 420 and 422 correspond to the latest price and quantity that a seller has offered with respect to a listing. In the example, users D and E are being offered different prices and quantities of the same listing.

Column 424 includes icons, links, or other suitable selectable or informational options that are available to the user of user listing subtable 400. For example, in response to the first listing of the RFQ, the user may either select a dollar sign indicating that the user wants to quote a price or an envelope indicating that the user wants to send the offeror an email or other notification requesting more information.

In response to the sixth listing of the BMW, the user of user listing subtable 400 may either confirm the buyer's acceptance of the $25,000 sales price, request more information, or reject the buyer's acceptance of the $25,000 sales price.

Although only a very limited example is illustrated in FIG. 6, user listing subtable 400 can be expanded to one or more forms with expanded or reduced detail. For example, the detail could be expanded to include delivery conditions, payment terms, credit availability, or any other suitable type of information.

Separate columns may be added for seller requested delivery terms and buyer requested delivery terms if those delivery terms are subject to negotiation using system 10. Any item that may be utilized in any commercial transaction may be included as a separate field or linked to from existing fields of user listing subtable 400. Although particular embodiments of the present invention have been explained in detail, it should be understood that various changes, substitutions, and alterations can be made to such embodiments without departing from the spirit and scope of the present invention as defined solely by the following claims.

What is claimed is:

1. A method of processing a transaction over a network, the method comprising: generating a listing associated with a first user and a good or service;
conducting a first transaction associated with the listing in response to a selection of a second user;
conducting a second transaction associated with the listing in response to a selection of a third user;
concluding the first transaction in response to the first user confirming an acceptance of the second user; and
canceling the second transaction in response to concluding the first transaction.

2. The method of claim 1, wherein the first and second transactions are conducted independently until the first transaction is concluded.

3. The method of claim 1, wherein the first transaction is not disclosed to the third user.

4. The method of claim 1, wherein the first and second transactions are conducted using a negotiation process defined by transaction states.

5. The method of claim 1, wherein the first transaction is conducted by the first and second users entering user selections in response to a changing state of the first transaction.

6. The method of claim 1, wherein conducting the first transaction includes allowing the first and second users to negotiate a price and a quantity of the listing.

7. The method of claim 1, wherein conducting the first transaction includes allowing the first user to withdraw an offer associated with the listing.

8. A method of processing a transaction over a network between a first user and a second user, the method comprising:
generating a listing associated with the first user, the listing including an offer;
receiving a first user selection associated with the second user in response to the listing, wherein the first user selection is selected from a first set of possible selections and wherein at least one of the first set of possible selections corresponds to the second user accepting the offer; and
receiving a further user selection associated with the first user in response to the first user selection being the possible selection corresponding to the second user accepting the offer, wherein the further user selection is selected from a second set of possible selections and wherein a first one of the second set of possible selections corresponds to the first user confirming the second user's acceptance of the offer and a second one of the second set of possible selections corresponds to the first user rejecting the second user's acceptance of the offer.

9. The method of claim 8, wherein generating a listing associated with the first user includes generating screening guidelines associated with the second user.

10. The method of claim 8, wherein generating a listing associated with the first user includes generating criteria for an autodecline operable to automatically decline counteroffers generated by the second user.

11. The method of claim 8, wherein receiving a first user selection includes receiving an update to a listing table of the first user.

12. The method of claim 8, and further comprising generating a notification message in response to receiving the first user selection.

13. The method of claim 8, wherein the further user selection corresponds to the first user's confirmation of the second user's acceptance and further including canceling a transaction with a third user associated with the listing in response to receiving the second user selection.

14. A system for processing a transaction over a network between a first user and a second user, the system comprising:
a message manager operable to communicate a user selection between the first and second user;
a state table operable to identify a previous state of the transaction and a first set of available user selections associated with the previous state; and
a state manager in communication with the message manager and the state table and operable to determine a current state of the transaction and a second set of available user selections associated with the current state, wherein the current state is determined in response to the previous state and further in response to the user selection.

15. The system of claim 14, wherein the state table includes an entry identifying the previous state of the transaction as an acceptance of an offer by the first user and further identifying the first set of available user selections to include a confirmation selection and a rejection selection.

16. The system of claim 14, wherein the message manager includes a wireless network interface operable to allow the message manager to communicate a wireless notification to the first or second user.

17. The system of claim 14, and further comprising a listing table in communication with the message manager, the listing table including a display of the current state of the transaction and being updated in response to the communicated user selection.

18. The system of claim 14, wherein the state manager is operable to finalize the transaction in response to receiving a confirmation as the user selection.

19. The system of claim 14, and further comprising a history manager in communication with the message manager and operable to maintain a history of each transaction associated with a listing.

20. The system of claim 14, and further comprising a user database including characteristics of the first and second users, the message manager being further operable to automatically generate user selections in response to the characteristics of the first and second users.

21. A method of processing a transaction over a network between a first user and a second user, the method comprising:
communicating a user selection between the first and second user;
accessing a previous state of the transaction and a first set of available user selections associated with the previous state;
identifying the previous state of the transaction as an acceptance of an offer by the first user and further identifying the first set of available user selections to include a confirmation selection and a rejection selection; and
determining a current state of the transaction and a second set of available user selections associated with the current state, wherein the current state is determined in response to the previous state and further in response to the user selection.
